(19) United States
(12) Patent Application Publication
(10) Pub. No.: US 2024/0108549 A1
(43) Pub. Date: Apr. 4, 2024

(54) MEDICINE FEEDER

(71) Applicant: Guotao Zeng, Jieyang, Guangdong (CN)

(72) Inventor: Guotao Zeng, Jieyang, Guangdong (CN)

(21) Appl. No.: 18/267,452

(22) PCT Filed: Feb. 5, 2021
(86) PCT No.: PCT/CN2021/075427

§ 371 Date: Jun. 14, 2023

(30) Foreign Application Priority Data
Dec. 14, 2020 (CN) 202011466849.X

(51) Int. Cl. A61J 7/00

(52) U.S. Cl. CPC A61J 7/0053

(57) ABSTRACT

The disclosure provides a medicine feeder comprising a first sleeve, a second sleeve, and a push rod. The first sleeve is provided with a first accommodation cavity for accommodating medicine liquid, and a first liquid outlet is provided at an end of the first accommodation cavity. The second sleeve is inserted in the first accommodation cavity and slidable along the first accommodation cavity. A sealing is achieved between the second sleeve and an inner wall of the first accommodation cavity. The second sleeve is provided with a second accommodation cavity for accommodating mouthwash, and a second liquid outlet is provided at an end of the second accommodation cavity proximal to the first liquid outlet. The push rod is inserted in the second accommodation cavity and slidable along the second accommodation cavity, and a sealing is achieved between the push rod and an inner wall of the second accommodation cavity.

### TECHNICAL FIELD

The disclosure relates to the technical field of medical instruments, and more particularly to a medicine feeder.

### BACKGROUND

The medicine feeder is a tool for medicine feeding of infants and young children aged 0-4 years or those who have problems in swallowing medications independently. Medicine feeding to the kids this age is always a struggle. With the help of a medicine feeder, medicine liquid may be fed instantly and successfully without waste. However, due to the bitter aftertaste of the medicine liquid, the kids may keep crying after medicine feeding. Then, it is hard to continue to feed mouthwash (e.g., clean water, sugar water, or the like), and too much time has to be spent on comforting kids.

### SUMMARY

An object of the disclosure is to overcome at least an existing problem. To this end, the disclosure provides a medicine feeder which can perform mouthwash feeding right after medicine feeding.

A medicine feeder according to an embodiment of a first aspect of the disclosure comprises: a first sleeve provided with a first accommodation cavity for accommodating medicine liquid, and the first accommodation cavity is provided at an end with a first liquid outlet; a second sleeve inserted in the first accommodation cavity and slidable along the first accommodation cavity, and a sealing is achieved between the second sleeve and an inner wall of the first accommodation cavity, the second sleeve is provided with a second accommodation cavity for accommodating mouthwash, and the second accommodation cavity is provided at an end proximal to the first liquid outlet with a second liquid outlet; and a push rod inserted in the second accommodation cavity and slidable along the second accommodation cavity, and a sealing is achieved between the push rod and an inner wall of the second accommodation cavity.

The medicine feeder according to the embodiment of the disclosure as least has advantages as follows. The disclosure provides arrangements of the first sleeve provided with the first accommodation cavity for accommodating medicine liquid, the second sleeve inserted in the first accommodation cavity and provided with the second accommodation cavity for accommodating mouthwash, and the push rod inserted in the second accommodation cavity. As a result, when the push rod is pulled, the mouthwash can enter through the first liquid outlet and also the second liquid outlet and then can be stored in the second accommodation cavity. Then, when the second sleeve is pulled, the medicine liquid can enter through the first liquid outlet and then can be stored in the first accommodation cavity. After that, when the second sleeve is pushed, the medicine liquid can be discharged through the first liquid outlet and fed into the kid's mouth. After medicine feeding, when the push rod is pushed further, the mouthwash can be discharged through the second liquid outlet and also the first liquid outlet and fed into the kid's mouth. Thus, during the whole feeding procedure, it is not necessary for the medicine feeder to be removed from the kid's mouth, and the feeding of mouthwash is right after medicine feeding. Therefore, the kid does not really experience too much bitter aftertaste of the medicine liquid, and is easy to comfort.

In some embodiments of the disclosure, a friction force between the push rod and the inner wall of the second accommodation cavity may be greater than a friction force between the second sleeve and the inner wall of the first accommodation cavity.

In some embodiments of the disclosure, it may further comprise a first sealing ring and a second sealing ring, wherein the first sealing ring may be sleeved outside the second sleeve, the second sealing ring may be sleeved outside the push rod, and an absolute value of a difference value between an outer diameter of the second sealing ring and an inner diameter of the second accommodation cavity may be greater than an absolute value of a difference value between an outer diameter of the first sealing ring and the first accommodation cavity.

In some embodiments of the disclosure, it may further comprise a first sealing ring and a second sealing ring, wherein the first sealing ring may be sleeved outside the second sleeve, the first sealing ring may be provided on its outer circumferential surface with several first protruding rings, the second sealing ring may be sleeved outside the push rod, the second sealing ring may be provided on its outer circumferential surface with several second protruding rings, and a number of the second protruding rings may be greater than a number of the first protruding rings.

In some embodiments of the disclosure, it may further comprise a sealing sleeve fixedly arranged at one end of the second sleeve provided with the second liquid outlet, and the sealing sleeve may be elastically deformable and provided with an expandable or reducible outlet gap for communicating the second liquid outlet with the first accommodation cavity.

In some embodiments of the disclosure, the outlet gap may be cross-shaped or linear-shaped.

In some embodiments of the disclosure, a pin lift for expanding the outlet gap may be arranged at an end of the first accommodation cavity provided with the first liquid outlet.

In some embodiments of the disclosure, a tube lift for expanding the outlet gap may be arranged at an end of the first accommodation cavity provided with the first liquid outlet, and the tube lift may be arranged in such a manner that a side wall of the tube lift surrounds the first liquid outlet and is provided with at least one notch.

In some embodiments of the disclosure, it may further comprise a sealing sleeve which is fixedly arranged at one end of the second sleeve provided with the second liquid outlet, and the sealing sleeve may be provided with a third outlet opening for communicating the second liquid outlet with the first accommodation cavity.

In some embodiments of the disclosure, wherein a first handle may be arranged at an end of the first sleeve distal to the first liquid outlet, a second handle may be provided at an end of the second sleeve distal to the second liquid outlet; the first handle and the second handle may be arranged in a staggered manner, or, a length of the second handle may be greater than a length of the first handle, or, a width of the second handle may be greater than a width of the first handle, or, a length of the second handle may be greater than a length of the first handle and a width of the second handle may be greater than a width of the first handle.

In some embodiments of the disclosure, wherein a ring pull may be arranged at an end of the push rod exposed from the second accommodation cavity.

Additional aspects and advantages of the disclosure will be set forth in the description that follows, and in part will be apparent from the description, or may be learned by practice of the invention.

### BRIEF DESCRIPTION OF THE DRAWINGS

The disclosure will be further described below in conjunction with the drawings and embodiments.

Herein:

FIG. 1 is a front view of a medicine feeder according to an embodiment of the disclosure;

FIG. 2 is a cross-sectional view of the medicine feeder taken along a line A-A of FIG. 1;

FIG. 3 is a front view of the medicine feeder of FIG. 1 in another state;

FIG. 4 is a cross-sectional view of the medicine feeder taken along a line B-B of FIG. 3;

FIG. 5 is a perspective view illustrating a first sleeve of the medicine feeder of FIG. 1;

FIG. 6 is a left view illustrating a sleeve assembly of the medicine feeder of FIG. 1.

Reference signs: 100. first sleeve; 110. injection nozzle; 111. injection opening; 120. sleeve body; 121. first liquid outlet; 122. tube lift; 123. first accommodation cavity; 124. first handle; 125. notches; 200. sleeve assembly; 210. sealing member; 211. sealing sleeve; 212. first sealing ring; 213. outlet gap; 214. first protruding rings; 220. second sleeve; 221. second liquid outlet; 222. second accommodation cavity; 223. second handle; 300. push rod assembly; 310. second sealing ring; 311. second protruding rings; 320. push rod; 321. ring pull.

### DETAILED DESCRIPTION OF ILLUSTRATED EMBODIMENTS

The embodiments of the disclosure illustrated in the drawings will be described in detail below. It should be understood that identical or same reference signs throughout the text indicate the identical or same parts or the parts with identical or same functions. It should be understood that the specific examples, while indicating exemplary embodiments of the disclosure, are intended for purposes of illustration only and are not intended to limit the scope.

It should be understood that, for convenience of description, the terms such as “up”, “down”, “front”, “rear”, “left” and “right” used in the description refer to position and orientation relationships depicted in the drawings. It is not intended to limit the disclosure by indicating or hinting components or elements having particular orientation relationships or being construed or operated with particular orientation relationships.

In the description, the term “several” means more than one, the term “plurality” means more than two, terms such as “greater than”, “less than” and “exceed” should be understood to exclude the boundary value, and terms such as “above”, “below” and “within” should be understood to include the boundary value. In addition, terms such as “first” and “second” used herein are merely intended to distinct the features from each other, but are not intended to indicate or hint relative importance or quantity or precedence relationship of the characteristics.

Unless defined otherwise, terms such as “arrange”, “mount” and “connect” used herein are intended to have the meanings commonly understood in a broad sense based on particular content of the technical solution by those skilled in the art.

In the description, terms such as “an embodiment”, “some embodiments”, “illustrative embodiment”, “example”, “particular embodiment” and “some examples” indicate that particular feature, structure, material, or characteristic described in the embodiment or example is included in at least one embodiment or example of the invention. In the description, the above illustrative expressions may not belong to one identical embodiment or example. Further, the described particular feature, structure, material, or characteristic may be combined in a suitable manner in any one or more of embodiments or examples.

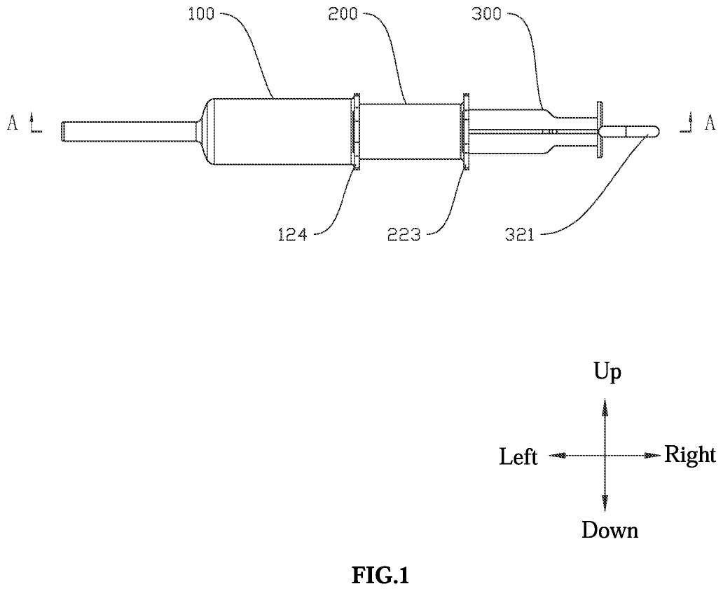

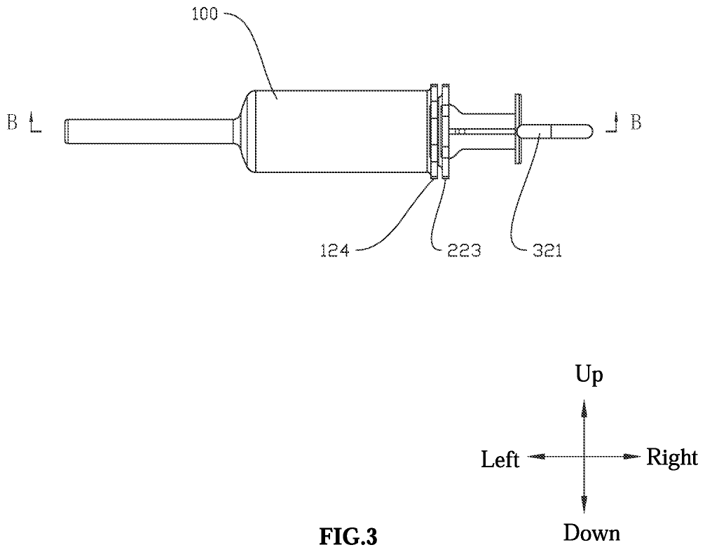

Referring to FIGS. 1-4, a medicine feeder according to an embodiment of the disclosure comprises a first sleeve 100, a second sleeve 220, and a push rod 320. The first sleeve 100 is provided with a first accommodation cavity 123 for accommodating medicine liquid. A first liquid outlet 121 is provided at the left end of the first accommodation cavity 123, and the medicine liquid and mouthwash can flow in and out through the first liquid outlet 121. An opening is provided at the right end of the first accommodation cavity 123. The second sleeve 220 may be inserted into the first accommodation cavity 123 through the opening provided at the right end of the first accommodation cavity 123. The second sleeve 220 is slidable along the first accommodation cavity 123. A sealing is achieved between the second sleeve 220 and the inner wall of the first accommodation cavity 123.

The second sleeve 220 is provided with a second accommodation cavity 222 for accommodating mouthwash. A second liquid outlet 221 is provided at an end (i.e., the left end) of the second accommodation cavity 222 proximal to the first liquid outlet 121, and the mouthwash can flow in and out through the second liquid outlet 221. An opening is provided at the right end of the second accommodation cavity 222. The push rod 320 may be inserted into the second accommodation cavity 222 through the opening provided at the right end of the second accommodation cavity 222. The push rod 320 is slidable along the second accommodation cavity 222. A sealing is achieved between the push rod 320 and the inner wall of the second accommodation cavity 222.

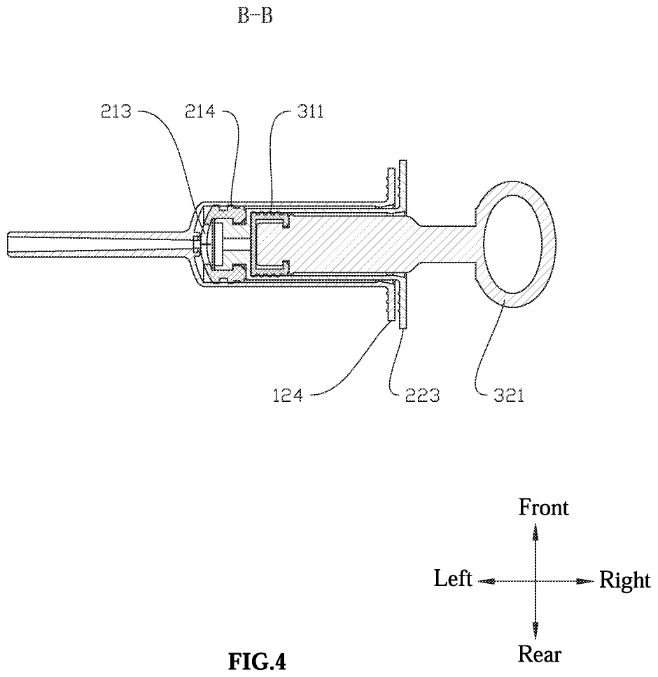

At first, the left end of the second sleeve 220 may abut against the left inner wall of the first accommodation cavity 123 (see FIG. 4). When the push rod 320 is pulled, the mouthwash may enter through the first liquid outlet 121 and also the second liquid outlet 221, and may be stored in the second accommodation cavity 222. Then, when the second sleeve 220 is pulled, the medicine liquid may enter through the first liquid outlet 121 and may be stored in the first accommodation cavity 123. After that, when the second sleeve 220 is pushed, the medicine liquid may be discharged through the first liquid outlet 121 and fed into a kid's mouth. After medicine feeding, when the push rod 320 is pushed further, the mouthwash may be discharged through the second liquid outlet 221 and also the first liquid outlet 121 and fed into the kid's mouth. In such a case, it doesn't need to be removed from the kid's mouth during the whole procedure of feeding, and the feeding of mouthwash is right after medicine feeding. Thus, the kid does not really experience too much bitter aftertaste of the medicine liquid, and is easy to comfort.

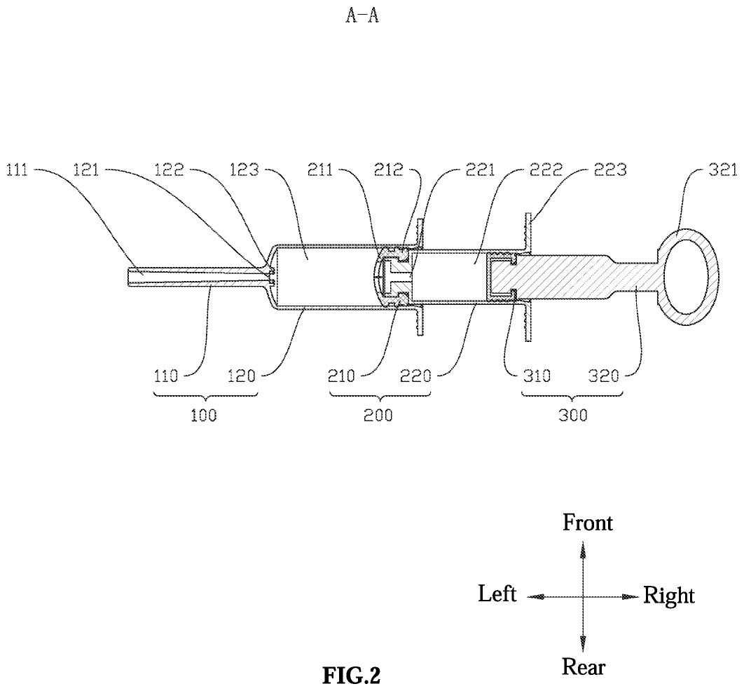

Referring to FIG. 2, to facilitate feeding of medicine liquid or mouthwash into the kid's mouth, the first sleeve 100 in some embodiments of the disclosure comprises an injection nozzle 110 and a sleeve body 120. Herein, the injection nozzle 110 is disposed at the left end of the sleeve body 120 and is provided with an injection opening 111. The first accommodation cavity 123 is defined by the sleeve body 120. The injection opening 111 is in communication with the first accommodation cavity 123 via the first liquid outlet 121. During medicine feeding, the injection nozzle 110 may be put into the kid's mouth, avoiding leakage of medicine liquid.

Referring to FIG. 2, in some embodiments of the disclosure, the friction force between the push rod 320 and the inner wall of the second accommodation cavity 222 is greater than the friction force between the second sleeve 220 and the inner wall of the first accommodation cavity 123. Thus, when the push rod 320 is pushed during medicine feeding, the second sleeve 220 slides along the first accommodation cavity 123, while the push rod 320 does not slide along the second accommodation cavity 222 at first. In such a case, the medicine liquid stored in the first accommodation cavity 123 can be fed into the kid's mouth while the mouthwash stored in the second accommodation cavity 222 is not discharged. When the left end of the second sleeve 220 abuts against the left inner wall of the first accommodation cavity 123, the medicine feeding has been finished, and the second sleeve 220 cannot be moved leftwards due to the first sleeve 100. Then, the push rod 320 can be moved to slide further along the second accommodation cavity 222, to feed the mouthwash into the kid's mouth. During the whole procedure of feeding, it only needs to push the push rod 320 to finish the medicine feeding and later the mouthwash feeding. It is convenient to use, even by one hand.

Overall, the medicine feeder according to the embodiment of the disclosure can be preloaded with the medicine liquid and the mouthwash. It allows feeding of the medicine liquid first and immediately followed by feeding of sugar water, into the kid's mouth, without interruption. On one hand, it reduces discomfort of the kids. On the other hand, it avoids interruption between the feeding of the medicine liquid and the feeding of mouthwash, thereby skipping over the trouble in mouthwash feeding to a shut mouth for another time.

Referring to FIG. 2, in a further embodiment of the disclosure, the medicine feeder further comprises a first sealing ring 212 and a second sealing ring 310. Herein, the second sealing ring 310 and the push rod 320 constitute a push rod assembly 300. The first sealing ring 212 is sleeved outside the second sleeve 220, and the second sealing ring 310 is sleeved outside the push rod 320. The absolute value of the difference value between the outer diameter of the second sealing ring 310 and the inner diameter of the second accommodation cavity 222 is greater than the absolute value of the difference value between the outer diameter of the first sealing ring 212 and the first accommodation cavity 123. That is, in the medicine feeder which has been assembled already, the deformation quantity of the second sealing ring 310 is greater than the deformation quantity of the first sealing ring 212.

In such a case, the pressure force between the first sealing ring 212 and the first sleeve 100 is greater than the pressure force between the second sealing ring 310 and the second sleeve 220. When the frictional coefficient between the first sealing ring 212 and the first sleeve 100 is equal or close to the frictional coefficient between the second sealing ring 310 and the second sleeve 220, the friction force between the push rod 320 and the inner wall of the second accommodation cavity 222 is greater than the friction force between the second sleeve 220 and the inner wall of the first accommodation cavity 123.

Referring to FIGS. 2 and 4, in a further embodiment of the disclosure, the medicine feeder likewise comprises the first sealing ring 212 and the second sealing ring 310, and the first sealing ring 212 is sleeved outside the second sleeve 220. The first sealing ring 212 is provided on its outer circumferential surface with several first protruding rings 214, and the second sealing ring 310 is sleeved outside the push rod 320. The second sealing ring 310 is provided on its outer circumferential surface with several second protruding rings 311. The number of the second protruding rings 311 is greater than the number of the first protruding rings 214.

In the case that the pressure force between the first sealing ring 212 and the first sleeve 100 is equal or close to the pressure force between the second sealing ring 310 and the second sleeve 220, and the frictional coefficient between the first sealing ring 212 and the first sleeve 100 is equal or close to the frictional coefficient between the second sealing ring 310 and the second sleeve 220 as well, the real area of contact (not the nominal area of contact) between the second sealing ring 310 and the inner wall of the second sleeve 220 can be increased by providing more second protruding rings 311. Thus, when the feeder has more second protruding rings 311 than the first protruding rings 214, the friction force between the push rod 320 and the inner wall of the second accommodation cavity 222 can be greater than the friction force between the second sleeve 220 and the inner wall of the first accommodation cavity 123.

Referring to FIGS. 2 and 4, in some embodiments of the disclosure, the medicine feeder comprises a sealing sleeve 211. Herein, the sealing sleeve 211 and the first sealing ring 212 are integrally formed and constitute a sealing member 210. The sealing member 210 and the second sleeve 220 constitute a sleeve assembly 200. The sealing sleeve 211 is fixedly arranged at the end (i.e., the left end) of the second sleeve 220 provided with the second liquid outlet 221. The sealing sleeve 211 is elastically deformable (due to the material such as silicone and rubber). The sealing sleeve 211 is provided with an outlet gap 213 (see FIG. 4) for communicating the second liquid outlet 221 with the first accommodation cavity 123. The outlet gap 213 may be expanded or reduced. When the outlet gap 213 is expanded, the mouthwash can easily flow into the first accommodation cavity 123 through the second liquid outlet 221. When the outlet gap 213 is reduced to its original size, it is not easy for the mouthwash to flow through the outlet gap 213 due to surface tension of liquid. Thus, the leakage of the mouthwash stored in the second accommodation cavity 222 can be avoided.

In such a case, in order to allow the mouthwash to flow through the second liquid outlet 221, the push rod 320 may be pushed, such that the outlet gap 213 may be expanded due to the mouthwash. Then, the mouthwash can flow into the first accommodation cavity 123. It is also conceivable to expand the outlet gap 213 by other methods (see below). When the outlet gap 213 is restored to its original size, the mouthwash can be stored in the second accommodation cavity 222 and the leakage of the mouthwash can be avoided.

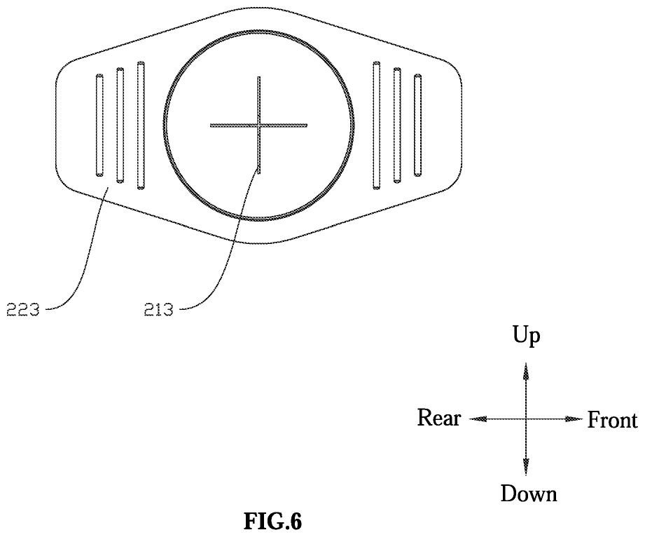

Referring to FIG. 6, the outlet gap 213 in a further embodiment of the disclosure may be cross-shaped. Such cross-shaped outlet gap 213 can allow fast flow of liquid when it is opened and can reduce leakage when it is closed.

In a further embodiment of the disclosure, the outlet gap 213 may be linear-shaped. Likewise, such linear-shaped outlet gap 213 can have liquid blocking and discharging functions.

In a further embodiment of the disclosure, a pin lift for expanding the outlet gap 213 is arranged at an end of the first accommodation cavity 123 provided with the first liquid outlet 121. The pin lift is arranged on the side of the first liquid outlet 121. When the sealing sleeve 211 gets close to the first liquid outlet 121, the flap beside the outlet gap 213 may be pushed by the pin lift to expand the outlet gap 213, thereby allowing the mouthwash to flow in or out easily.

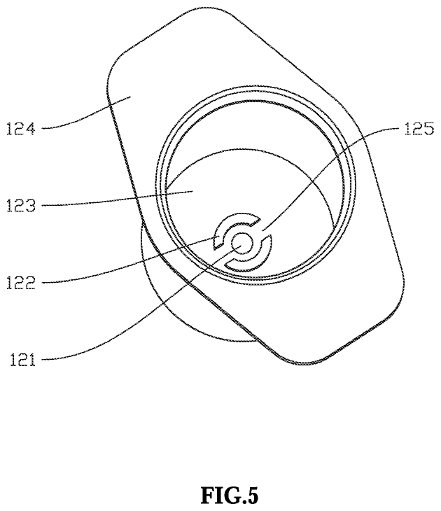

Referring to FIGS. 2 and 5, in a further embodiment of the disclosure, a tube lift 122 for expanding the outlet gap 213 is arranged at an end of the first accommodation cavity 123 provided with the first liquid outlet 121. The side wall of the tube lift 122 surrounds the first liquid outlet 121, and the side wall of the tube lift 122 is provided with two notches 125. When sealing sleeve 211 contacts the tube lift 122 and keeps moving leftwards gradually, the residual medicine liquid in the first accommodation cavity 123 may flow to the first liquid outlet 121 via the notches 125. The tube lift 122 would not hinder the residual medicine liquid to flow out. In addition, the flaps beside the outlet gap 213 may be pushed by the tube lift 122 to expand the outlet gap 213, thereby allowing the mouthwash to flow in or out easily.

In addition, the tube lift 122 may be divided into two arc-shaped pieces by the two notches 125. If the outlet gap 213 is linear-shaped, the flaps at two sides of the outlet gap 213 may be pushed by the two arc-shaped pieces, to quickly open the outlet gap 213.

In addition, one, three, or four notches 125 are also conceivable. Herein, the tube lift 122 may be divided into four arc-shaped pieces by four notches 125. If the outlet gap 213 is cross-shaped, the four flaps adjacent the outlet gap 213 may be pushed by the four arc-shaped pieces respectively, to quickly open the outlet gap 213.

In some embodiments of the disclosure, the sealing sleeve 211 is provided with a third outlet opening for communicating the second liquid outlet 211 with the first accommodation cavity 123. By means of the third outlet opening, the second liquid outlet 211 and the first accommodation cavity 123 can be in direct communication with each other, which facilitates flowing in and out of the mouthwash.

Referring to FIGS. 2 and 4, in some embodiments of the disclosure, a first handle 124 is arranged at the end (i.e., the right end) of the first sleeve 100 distal to the first liquid outlet 121, a second handle 223 is arranged at the end (i.e., the right end) of the second sleeve 220 distal to the second liquid outlet 221, and a length of the second handle 223 is greater than a length of the first handle 124 (see FIG. 4). In such a case, the second sleeve 220 can be easily pressed into the first accommodation cavity 123 by means of the first handle 124 and the second handle 223. Further, as the length of the second handle 223 is greater than the length of the first handle 124, when the first handle 124 is overlapped with the second handle 223, the first handle 124 and the second handle 223 can be easily separated from each other, whereby the second sleeve 220 can be pulled out.

In addition, the first handle 124 and the second handle 223 may be arranged in a staggered manner. For example, the first handle 124 may be offset from the second handle 223 by 45°, or 60°, or 90°. As the first handle 124 and the second handle 223 are staggered, they can be easily separated from each other when they are overlapped with each other.

In addition, a width of the second handle 223 may be greater than a width of the first handle 124. In such a case, the first handle 124 and the second handle 223 can be easily separated from each other when they are overlapped with each other, by holding the second handle 223 along its width direction.

In addition, a length of the second handle 223 may be greater than a length of the first handle 124, and a width of the second handle 223 may be greater than a width of the first handle 124. In such a case, the first handle 124 and the second handle 223 can be easily separated from each other by holding the second handle 223 along either its length or width direction. It is convenient to use.

Referring to FIG. 2, in some embodiments of the disclosure, a ring pull 321 is arranged on the push rod 320 at the end (i.e., the right end) exposed from the second accommodation cavity 222. In such a case, with the help of the ring pull 321, the push rod 320 can be pulled out of the second accommodation cavity 222, to facilitate filling of the mouthwash or medicine liquid.

The invention is described above in detail in conjunction with the drawings. The embodiments are not intended to limit the scope of the invention in any form. Those skilled in the art may modify them to obtain equivalents without departing from the scope of the invention. Further, mutually non-exclusive embodiments and features thereof may be combined with each other.

1. A medicine feeder, comprising:
a first sleeve provided with a first accommodation cavity for accommodating medicine liquid, a first liquid outlet being provided at an end of the first accommodation cavity;
a second sleeve inserted in the first accommodation cavity and slidable along the first accommodation cavity, a sealing being achieved between the second sleeve and an inner wall of the first accommodation cavity; the second sleeve being provided with a second accommodation cavity for accommodating mouthwash, and a second liquid outlet being provided at an end of the second accommodation cavity proximal to the first liquid outlet; and
a push rod inserted in the second accommodation cavity and slidable along the second accommodation cavity, and a sealing being achieved between the push rod and an inner wall of the second accommodation cavity.

2. The medicine feeder according to claim 1, wherein a friction force between the push rod and the inner wall of the second accommodation cavity is greater than a friction force between the second sleeve and the inner wall of the first accommodation cavity.

3. The medicine feeder according to claim 2, further comprising a first sealing ring and a second sealing ring, wherein the first sealing ring is sleeved outside the second sleeve, the second sealing ring is sleeved outside the push rod, and an absolute value of a difference value between an outer diameter of the second sealing ring and an inner diameter of the second accommodation cavity is greater than an absolute value of a difference value between an outer diameter of the first sealing ring and the first accommodation cavity.

4. The medicine feeder according to claim 2, further comprising a first sealing ring and a second sealing ring, wherein the first sealing ring is sleeved outside the second sleeve, the first sealing ring is provided on its outer circumferential surface with several first protruding rings, the second sealing ring is sleeved outside the push rod, the second sealing ring is provided on its outer circumferential surface with several second protruding rings, and a number of the second protruding rings is greater than a number of the first protruding rings.

5. The medicine feeder according to claim 1, further comprising a sealing sleeve which is fixedly arranged at one end of the second sleeve provided with the second liquid outlet, the sealing sleeve being elastically deformable and provided with an expandable or reducible outlet gap for communicating the second liquid outlet with the first accommodation cavity.

6. The medicine feeder according to claim 5, wherein the outlet gap is cross-shaped or linear-shaped.

7. The medicine feeder according to claim 5, wherein a pin lift for expanding the outlet gap is arranged at an end of the first accommodation cavity provided with the first liquid outlet.

8. The medicine feeder according to claim 5, wherein a tube lift for expanding the outlet gap is arranged at an end of the first accommodation cavity provided with the first liquid outlet, the tube lift is arranged in such a manner that a side wall of the tube lift surrounds the first liquid outlet and is provided with at least one notch.

9. The medicine feeder according to claim 1, further comprising a sealing sleeve which is fixedly arranged at one end of the second sleeve provided with the second liquid outlet, and the sealing sleeve is provided with a third outlet opening for communicating the second liquid outlet with the first accommodation cavity.

10. The medicine feeder according to claim 1, wherein a first handle is arranged at an end of the first sleeve distal to the first liquid outlet, a second handle is provided at an end of the second sleeve distal to the second liquid outlet; the first handle and the second handle are arranged in a staggered manner, or, a length of the second handle is greater than a length of the first handle, or, a width of the second handle is greater than a width of the first handle, or, a length of the second handle is greater than a length of the first handle and a width of the second handle is greater than a width of the first handle.

11. The medicine feeder according to claim 10, wherein a ring pull is arranged at an end of the push rod exposed from the second accommodation cavity.

12. The medicine feeder according to claim 2, further comprising a sealing sleeve which is fixedly arranged at one end of the second sleeve provided with the second liquid outlet, the sealing sleeve being elastically deformable and provided with an expandable or reducible outlet gap for communicating the second liquid outlet with the first accommodation cavity.

13. The medicine feeder according to claim 3, further comprising a sealing sleeve which is fixedly arranged at one end of the second sleeve provided with the second liquid outlet, the sealing sleeve being elastically deformable and provided with an expandable or reducible outlet gap for communicating the second liquid outlet with the first accommodation cavity.

14. The medicine feeder according to claim 4, further comprising a sealing sleeve which is fixedly arranged at one end of the second sleeve provided with the second liquid outlet, the sealing sleeve being elastically deformable and provided with an expandable or reducible outlet gap for communicating the second liquid outlet with the first accommodation cavity.

15. The medicine feeder according to claim 2, further comprising a sealing sleeve which is fixedly arranged at one end of the second sleeve provided with the second liquid outlet, and the sealing sleeve is provided with a third outlet opening for communicating the second liquid outlet with the first accommodation cavity.

16. The medicine feeder according to claim 3, further comprising a sealing sleeve which is fixedly arranged at one end of the second sleeve provided with the second liquid outlet, and the sealing sleeve is provided with a third outlet opening for communicating the second liquid outlet with the first accommodation cavity.

17. The medicine feeder according to claim 4, further comprising a sealing sleeve which is fixedly arranged at one end of the second sleeve provided with the second liquid outlet, and the sealing sleeve is provided with a third outlet opening for communicating the second liquid outlet with the first accommodation cavity.
